(19) United States
(12) Patent Application Publication
(10) Pub. No.: US 2024/0213012 A1
(43) Pub. Date: Jun. 27, 2024

(54) ION GENERATOR, MASS SPECTROMETER AND METHOD OF GENERATING IONS

(71) Applicant: SHIMADZU CORPORATION, Kyoto-shi (JP)

(72) Inventors: Wenjian SUN, Shanghai (CN); Zhi Geng, Shanghai (CN)

(73) Assignee: SHIMADZU CORPORATION, Kyoto-shi (JP)

(21) Appl. No.: 18/541,196

(22) Filed: Dec. 15, 2023

(30) Foreign Application Priority Data
Dec. 23, 2022 (CN) 202211666403.0

(51) Int. Cl. H01J 49/16

(52) U.S. Cl. CPC H01J 49/164

(57) ABSTRACT

The technical solution of the present disclosure provides an ion generator for dissociating sample ions for the second time by laser, of which the dissociation efficiency is further improved with a lower cost. The ion generator includes: a desorption device configured to desorb sample particles into a pre-determined area; a light source emitting a light beam and focusing the light beam to the pre-determined area, thereby ionizing, fragmenting or atomizing the sample particles in the pre-determined area; and a focusing reflector for reflecting the light beam that is emitted by the light source and travels through the pre-determined area, and focusing the light beam to the pre-determined area, thereby ionizing, fragmenting or atomizing the sample particles in the pre-determined area at least once again, during which each time the light beam is reflected on the surface of the focusing reflector, the light beam is focused to the pre-determined area correspondingly.

### TECHNICAL FIELD

The present disclosure relates to the technical field of mass analysis, and more particularly relates to an ion generator, a mass spectrometer and a method of generating ions.

### BACKGROUND ART

When some existing substance analyzing instruments are used for analyzing a substance, it is required to first ionize, fragment or atomize sample particles of the substance. Then, the sample particles dissociated from sample molecules are detected to reveal the elemental composition or molecular information of the substance. Accordingly, an ion generator is an important component of such substance analyzing instruments.

After research, people have found that a large number of particles that are not completely dissociated are generally produced after the sample is dissociated one time, which limits the dissociation efficiency of the ion generator to a great extent, thereby limiting the sensitivity of an analytical instrument, so the sample particles are often dissociated several times by ion generators in the prior art. Taking Matrix Assisted Laser Desorption/Ionization (MALDI) as an example, in the document published by Soltwisch et al. at 2015, “Mass spectrometry imaging with laser-induced postionization”, a MALDI-QTOF (time of flight) mass spectrometer was disclosed, which uses a laser source with the wavelength adjustable in the range of 260-280 nm to postionize particle plume obtained from primary ionization. The mass spectrometer could increase the ion yield of some lipid substances and small-molecule substances by nearly three orders of magnitude. The postionization technique is now known as a MAIDI-2 technique.

However, the ionization efficiency of the postionization techniques similar to the MALDI-2 technique still needs to be further improved.

A MALDI-IM (ion mobility)-TOF mass spectrometer utilizing a pair of oppositely placed mirrors to improve the ionization efficiency is disclosed in the patent with the application No. U.S. Pat. No. 8,558,168B2. However, in this technical solution, the focal position of the mirror is aligned with the area where the particle plume is located. In this way, it is necessary to carry out reflection many times to make laser be focused at the particle plume one time, which will greatly reduce the ionization efficiency of postionization. Moreover, the attenuation of laser energy may be caused each time reflection is carried out, and the postionization effect is positively correlated with the laser energy, so to ensure the ionization effect after the reflection, higher requirements are put forwards for the laser energy. Furthermore, some of reflected and unfocused light will deviate from the position of a focus. In order to cooperate with the deviated light, it is often required to change the size and position of the device used for primary ionization, consequently making the optical path device inside the device more complex and difficult to implement.

A device and method for mass spectrometry of particles is proposed in the patent with the application No. CN101592628A, in which an ion generator that repeatedly reflects laser in a resonant cavity to the vicinity of sample particles in accordance with the principle of an optical resonant cavity so as to ionize the sample particles many times is specifically disclosed. However, the dissociation efficiency of laser desorption/ionization is not only affected by the time and space of the action of the laser with the substance sample, but also by the intensity of the laser. The resonant cavity in the patent with the application No. CN101592628A needs to reflect the laser many times by combining a semi-transparent mirror and a total reflector. The laser penetrates the semi-transparent mirror to be incident into the resonant cavity, which results in a substantial loss of laser power. Generally, the concave mirror in the resonant cavity has a reflectivity R>99.99%, and since the laser is incident from the center of the first concave mirror, only about 10⁻⁴ of the power of the laser can enter the resonant cavity. For the purpose of making the incident laser reach an intensity at which the substance sample can be dissociated, it is necessary to provide incident laser of higher energy. However, the increase of the laser energy will cause a large size and a higher cost of the ion generator.

Therefore, an improved technical solution is needed to solve the above problems of the existing ion generator.

### SUMMARY OF THE INVENTION

In consideration of the above problems in the prior art, the technical solution of the present disclosure provides an ion generator, of which the desorption (i.e., ionization, fragmentation or atomization) efficiency is further improved with a lower cost.

The present disclosure provides an ion generator, and the ion generator includes: a desorption device configured to desorb sample particles into a pre-determined area: a light source emitting a light beam and focusing the light beam to the pre-determined area, thereby ionizing, fragmenting or atomizing the sample particles in the pre-determined area; and a focusing reflector for reflecting the light beam that is emitted by the light source and travels through the pre-determined area, and focusing the light beam to the pre-determined area, thereby ionizing, fragmenting or atomizing the sample particles in the pre-determined area at least once again, during which each time the light beam is reflected on the surface of the focusing reflector, the light beam is focused to the pre-determined area correspondingly.

According to the technical solution, by arranging the focusing reflector, the light beam that has been focused to and passes through the pre-determined area is reflected back and refocused in the pre-determined area, so as to repeat the dissociation of the sample particles, which can effectively improve the dissociation efficiency of the sample particles, and also avoid the complexity of the device caused by beam deviation. In addition, because each time the light beam is reflected, the light beam is focused correspondingly, the number of times at which laser is focused in the pre-determined area increases, and the energy loss caused each time the laser is focused is reduced, which can further enhance the dissociation efficiency of the sample particles.

As an optional technical solution, the focusing reflector includes a first concave mirror arranged opposite to the light source with the pre-determined area therebetween, and the sphere center of the first concave mirror is located in the pre-determined area.

According to the technical solution, by arranging one concave mirror on the other side of the light source, the light beam after being focused one time can be reflected and focused again. By arranging the sphere center of the first concave mirror in the pre-determined area, the light beam after being focused one time can be focused to the pre-determined area again, which enhances the number of times at which the light beam repeatedly dissociates the sample particles, and also takes into account the simplification of the device while improving the dissociation efficiency.

As an optional technical solution, the focusing reflector further includes a second concave mirror arranged opposite to the first concave mirror with the pre-determined area therebetween, and the sphere center of the second concave mirror is located in the pre-determined area.

According to the technical solution, the first concave mirror and the second concave mirror are arranged opposite to each other with the pre-determined area therebetween, and the sphere centers thereof are both arranged in the pre-determined area, so that the light beam focused to the pre-determined area from the light source can be reflected between the first concave mirror and the second concave mirror. Each time the light beam is reflected, the light beam will be focused to the pre-determined area again, so that the light beam can be focused each time and the focused light beam can overlap with the sample particles in the pre-determined area, which further enhances the dissociation efficiency of the ion generator.

As an optional technical solution, the light beam is repeatedly reflected and focused in the pre-determined area between the first concave mirror and the second concave mirror.

According to the technical solution, for example, by arranging the reflective surfaces of the first concave mirror and the second concave mirror as curved surfaces extending around a common sphere center, or, by arranging the first concave mirror and the second concave mirror as a plurality of concave mirror assemblies with the same sphere center, the light beam can be repeatedly reflected and focused between the first concave mirror and the second concave mirror, thereby further enhancing the dissociation efficiency.

As an optional technical solution, the light beam is incident to the surface of the first concave mirror adjacently to the edge of the second concave mirror. According to the technical solution, the light beam is incident from the edge of the second concave mirror so that the number of times at which the light beam is focused and reflected is greater. In addition, compared with the technique that the light beam is incident from a semi-transparent mirror to a resonant cavity in the prior art, the energy loss of light during incidence can be avoided.

As an optional technical solution, the second concave mirror has a through hole, and the light beam is incident on the surface of the first concave mirror through the through hole.

According to the technical solution, when the light beam incident from the through hole of the second concave mirror is reflected between the first concave mirror and the second concave mirror having the same or similar sphere centers, the light beam can be reflected back and forth between the reflective surfaces of the first concave mirror and the second concave mirror a certain number of times, and at the same time, it is possible to avoid the energy consumption of the light beam during incidence.

As an optional technical solution, the light source includes a convex lens whose focal point is located in the pre-determined area.

According to the technical solution, a parallel light beam emitted by the light source is focused in the pre-determined area by means of the convex lens, and focused high-energy photons interact with particle plume in the pre-determined area, and particles in the particle plume are dissociated.

As an optional technical solution, optical axis of the convex lens is coaxial with optical axis of the first concave mirror.

According to the technical solution, the convex lens and the first concave mirror which are coaxially arranged can ensure that the reflected light beam can be accurately refocused to the pre-determined area, and also simplify the structure of the device.

As an optional technical solution, the sample particles are ions, neutral particles, or a combination of both.

As an optional technical solution, the desorption device is a laser desorption device, a thermal desorption device, an ultrasonic desorption device, or a combination thereof.

As an optional technical solution, the desorption device is a matrix-assisted laser desorption device, and the pre-determined area is an area adjacent to a sample electrode plate of the matrix-assisted laser desorption device and traversed by the particle plume of the matrix-assisted laser desorption device.

As an optional technical solution, the energy loss caused each time the light beam is reflected and focused by the focusing reflector is less than 10%.

According to the technical solution, for example, a total reflection concave mirror is used as the focusing reflector, which can reduce the energy loss each time the light beam is reflected and focused, so that the light beam still has high energy after being reflected many times, thereby being able to dissociate the sample particles.

The present disclosure further provides an ion generator, and the ion generator includes a matrix-assisted laser desorption device having a sample electrode plate: a laser light source: a convex lens coaxially arranged with the laser light source, whose focal point is in a pre-determined area that is adjacent to the sample electrode plate of the matrix-assisted laser desorption device and traversed by the particle plume of the matrix-assisted laser desorption device: a first concave mirror arranged opposite to the laser light source with the pre-determined area therebetween, whose sphere center is located in the pre-determined area.

According to the technical solution, the laser light source of the matrix-assisted laser desorption device emits laser to a substance sample on the sample electrode plate to dissociate the substance sample for the first time. The substance sample generates particle plume after being dissociated for the first time. After the particle plume escapes to the pre-determined area near the sample electrode plate, a light beam emitted by the light source is focused and irradiated by the convex lens. The particle plume in the pre-determined area is dissociated for the second time. The focused light beam is incident on the surface of the first concave mirror, and is reflected and focused to the pre-determined area again to dissociate the particle plume in the pre-determined area for the third time.

The ion generator can dissociate the sample particles three times by means of simple device setting, so that the degree of dissociation of the sample particles can be effectively enhanced in the aspect of the time and space of the action of the light beam with the sample particles. The light beam emitted by the light source of the ion generator provided by the present disclosure is focused to the pre-determined area. The reflected light beam is focused to the pre-determined area again, so that the degree of dissociation of the sample particles can be effectively enhanced under the condition that the beam energy is the same, thus enhancing the dissociation efficiency of the ion generator.

As an optional technical solution, the ion generator further includes: a second concave mirror arranged opposite to the first concave mirror with the pre-determined area therebetween, and the sphere center of the second concave mirror is located in the pre-determined area.

As an optional technical solution, the matrix-assisted laser desorption device further includes a mirror system for the control of the deflecting angle of the desorption laser, in order for the position control of the desorption laser spots on the sample electrode plate.

According to the technical solution, the mirror system is capable of controlling the position of the light spot of desorption laser on the sample electrode plate by changing the deflecting angle of the light beam to desorb sample particles in a plurality of pre-determined areas near the sample electrode plate, and also controlling the position of the light spot to move in the direction of flow of sample plume, thereby facilitating faster scanning the sample particles in the pre-determined area at low inertia without moving the sample electrode plate.

The present disclosure further provides a mass spectrometer, and the mass spectrometer includes the ion generator according to any one or more of the above technical solutions.

The present disclosure further provides a method of generating ions, where the method of generating ions includes the following steps:
desorbing sample particles into a pre-determined area:
emitting a light beam and focusing the light beam to the pre-determined area, thereby ionizing, fragmenting or atomizing the sample particles in the pre-determined area; and
reflecting the light beam that travels through the pre-determined area, and focusing the light beam to the pre-determined area, thereby ionizing, fragmenting or atomizing the sample particles in the pre-determined area at least once again, during which each time the light beam is reflected, the light beam is focused to the pre-determined area correspondingly.

### DESCRIPTIONS OF THE DRAWINGS

FIG. 1 is a schematic view of modules of an ion generator provided by embodiments of the present disclosure;

FIG. 2 is a structural schematic view of an ion generator provided by an embodiment of the present disclosure;

FIG. 3 is a structural schematic view of an ion generator provided by another embodiment of the present disclosure:

FIG. 4 is a structural schematic view of an ion generator provided by still another embodiment of the present disclosure; and

FIG. 5 is a flow chart of a method of generating ions provided by an embodiment of the present disclosure.

List of Reference Numerals: 1: light source; 11—light beam generator; 12—convex lens; 2—desorption device; 20—matrix-assisted laser desorption device; 21—laser light source; 22—sample electrode plate; 3—focusing reflector; 31—first concave mirror; 32—second concave mirror; 321—through hole; 4—pre-determined area.

### DETAILED DESCRIPTION

Exemplary embodiments of the present disclosure are roughly described below with reference to the accompanying drawings. Furthermore, the embodiments of the present disclosure are not limited to the following embodiments, and a variety of embodiments using the technical concept of the present disclosure can be used.

### Term

Unless otherwise specified, the term “time during which a light beam overlaps with sample particles” means the total duration during which the light beam overlaps with the sample particles. For example, the time during which the light beam after being reflected for the first time overlaps with sample particle plume when passing through a pre-determined area 4 is 0.05. The time during which the light beam after being reflected for the second time overlaps with sample particle plume when passing through the pre-determined area 4 is 0.05. Then the “time during which the light beam overlaps with the sample particles” in the two reflections is 0.05+0.05-0.1. The term “space in which the light beam overlaps with the sample particles” refers to the volume of the space where the light beam overlaps with the sample particles, for example, the volume of overlap between the light beam after being reflected for the first time and the pre-determined area 4 is n1, and the volume of overlap between the light beam after being reflected for the second time and the pre-determined area 4 is n2, and the space n is a union set of n1 and n2. The concentration of the sample particle in the pre-determined area 4 is c, and then the volume of overlap between the light beam and the sample particle in the two reflections is n*c.

The term “dissociation” refers to the process of ionization, fragmentation or atomization of the sample particles, and does not specifically refer to the ionization of the sample particles, while the corresponding term “degree of dissociation” refers to the proportion of the sample particles that are ionized, fragmented or atomized. The higher the proportion, the higher the degree of dissociation of the sample.

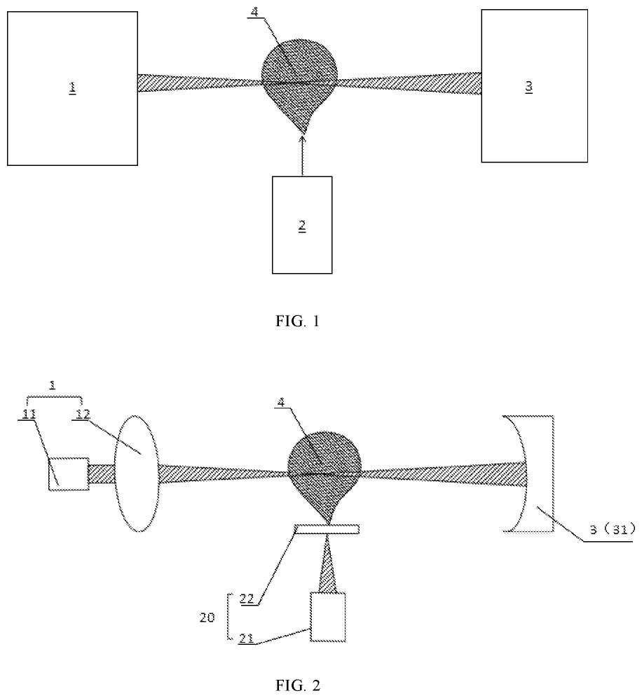

This embodiment provides an ion generator. FIG. 1 is a schematic view of modules of an ion generator provided by embodiments of the present disclosure. As shown in FIG. 1, the ion generator provided by the present disclosure includes a desorption device 2, a light source 1, and a focusing reflector 3.

In this embodiment, by arranging the focusing reflector 3, the light beam that has been focused to and passes through the pre-determined area 4 is reflected back and refocused to the pre-determined area 4, so as to repeat the dissociation of the sample particles, which can effectively improve the dissociation efficiency of the sample particles. In addition, because each time the light beam is reflected, the light beam is focused correspondingly (in this embodiment, illustration is carried out by taking that each time the light beam is reflected, the light beam is focused correspondingly as an example), the number of times at which laser is focused to the pre-determined area 4 is increased by one. Compared with the mode that the light beam is focused one time only when the light beam is reflected many times, the energy loss caused each time the light beam is focused is reduced, which can further enhance the dissociation efficiency of the sample particles.

Specifically, in this embodiment, the desorption device 2 desorbs a sample with the substance to be analyzed. The desorption device 2 may be a laser desorption device, a thermal desorption device, an ultrasonic desorption device, or a combination thereof, and there is no limitation herein. Atoms, neutral particles, ions, or ion fragments generated by desorption of the sample form particle plume. The particle plume escapes to the pre-determined area 4, and the pre-determined area 4 is generally in the vicinity of the sample, or, the particle plume may be guided by other guiding devices to a distant pre-determined area 4.

A light beam emitted by the light source 1 contains high-energy photons capable of dissociating the sample particles, such as UV laser, and the light source 1 is capable of emitting the light beam and focusing the light beam in the pre-determined area 4 to dissociate the particle plume in the pre-determined area 4 for the first time.

The focusing reflector 3 receives the light beam after being focused for the first time, and reflects and focuses the light beam after being focused for the first time into the pre-determined area 4 again, so as to dissociate the particle plume in the pre-determined area 4 for the second time.

In this embodiment, the sample particles can be dissociated for at least two times by simple device setting, i.e., the focused light beam overlaps with the sample particles and irradiates the sample particles at least two times. By increasing the number of times of irradiation, the time and space in which the light beam overlaps with the sample particles can be increased, which can effectively enhance the degree of dissociation of the sample particles. Moreover, the ion generator in this embodiment is capable of focusing the light beam emitted by the light source 1 to the pre-determined area 4, and the reflected light beam is focused to the pre-determined area 4 again, thereby enhancing the density of the high-energy photons in the pre-determined area 4, enhancing the degree of dissociation of the sample particles, and improving the dissociation efficiency of the ion generator.

FIG. 2 is a structural schematic view of an ion generator provided by an embodiment of the present disclosure: The structure illustrated in FIG. 2 is a more specific exemplary structure of the ion generator provided by the present disclosure, and the ion generator provided in this embodiment is described more specifically below in conjunction with the accompanying drawing.

In combination with FIG. 1 and FIG. 2, the desorption device 2 in this embodiment may be a matrix-assisted laser desorption device 20, and the pre-determined area 4 is an area adjacent to a sample electrode plate 22 of the matrix-assisted laser desorption device 20 and traversed by the particle plume of the matrix-assisted laser desorption device 20. Specifically, the matrix-assisted laser desorption device 20 includes a laser light source 21 and the sample electrode plate 22, the sample electrode plate 22 carries a mixture of a matrix and a substance sample, and the laser light source 21 emits laser to the sample electrode plate 22. Exemplarily, the laser emitted by the laser light source 21 is UV laser.

In this embodiment, the matrix-assisted laser desorption device 20, compared to other desorption devices, is capable of transmitting the laser energy to the substance sample by means of the matrix, so that the substance sample can be protected. Especially for some difficult-to-vaporize, or heat-sensitive biomacromolecule substance samples, the energy of laser is transmitted to the substance sample by means of the matrix to dissociate the substance sample.

However, because the dissociation process of the matrix-assisted laser desorption device 20 is relatively mild, the particle plume generated after the first-time dissociation contains a large number of neutral particles that are not completely dissociated. The particle plume generally escapes from the sample electrode plate 22 of the matrix-assisted laser desorption device 20 in the direction away from the laser light source 21 of the matrix-assisted laser desorption device 20, so the pre-determined area 4 is arranged in the area adjacent to the sample electrode plate 22 (for example, as illustrated in FIG. 2, the laser light source 21 is below the sample electrode plate 22, and the pre-determined area 4 is arranged near the position above the sample electrode plate), so that the escaping particle plume can be made to basically be in the pre-determined area 4, the concentration of the sample particles in the pre-determined area 4 increases, the space in which the light beam overlaps with the sample particles during second-time desorption increases, and the desorption efficiency of the ion generator is improved.

In some preferred embodiments, the matrix-assisted laser desorption device 20 further includes a mirror system (not shown) for changing the deflecting angle of a desorption laser beam. The mirror system may be an assembly arranged between the laser light source 21 and the sample electrode plate 22 and including at least two or more mirrors. Specifically, after the laser beam emitted by the laser light source 21 is reflected by the plurality of mirrors, the light spot thereof falls onto the sample electrode plate 22, where at least one mirror can move or rotate the reflective surface, thereby controlling a laser light path so that the reflected light spot can move on the sample electrode plate 22, i.e., the sample particles in the pre-determined area 4 above the sample electrode plate 22 can be scanned without moving the sample electrode plate 22.

The light source 1 emits a light beam and focuses the light beam to the pre-determined area 4, thereby ionizing, fragmenting, or atomizing the sample particles in the pre-determined area 4. Specifically, the light source 1 includes a light beam generator 11 and a convex lens 12 arranged between the beam generator 11 and the pre-determined area 4, where a focus of the convex lens 12 is located in the pre-determined area 4. A parallel light beam emitted by the beam generator 11 is focused in the pre-determined area 4 via the convex lens 12, and the focused high-energy photons overlap with the particle plume in the pre-determined area 4. The particles in the particle plume are dissociated. It is to be noted that the energy of the light beam emitted by the beam generator 11 can be adjusted according to the different needs of dissociation. For example, when the sample particles are ionized, the light beam can be UV laser. When it is necessary to fragment the sample particles, the emitted light beam can be adjusted to a higher-energy light beam according to the needs.

The focusing reflector 3 is used for reflecting the light beam that is emitted by the light source 1 and travels through the pre-determined area 4, and focusing the light beam to the pre-determined area 4, thereby ionizing, fragmenting or atomizing the sample particles in the pre-determined area 4 at least once again, during which each time the light beam is reflected on the surface of the focusing reflector 3, the light beam is focused to the pre-determined area 4 correspondingly. Specifically, the focusing reflector 3 can be a concave mirror, where the focusing reflector 3 is preferably a high-reflectivity concave mirror, which can reduce the energy loss when the light beam is reflected. For example, by selecting a concave mirror with the reflectivity R>99.99%, the energy loss caused each time the light beam is reflected and focused by the focusing reflector 3 is less than 10% so as to enable the light beam to still have high energy even after being reflected many times, thereby being able to dissociate the sample particles.

The focusing reflector 3 is exemplified in FIG. 2 as a first concave mirror 31. As shown in FIG. 2, the first concave mirror 31 is arranged opposite to the light source 1 with the pre-determined area 4 therebetween, and the sphere center of the first concave mirror 31 is located in the pre-determined area 4. By arranging the first concave mirror 31 on the other side of the light source 1, the light beam after being focused one time can be reflected and focused again. By arranging the sphere center of the first concave mirror 31 in the pre-determined area 4, the light beam after being focused one time can be focused in the pre-determined area again, which enhances the energy of the light beam while improving the time and space in which the light beam overlaps with the sample particles.

Specifically, on the basis that the first concave mirror 31 is arranged opposite to the light source 1 with the pre-determined area 4 therebetween, the first concave mirror 31 is also coaxial with the optical axis of the concave mirror of the light source 1. The convex lens and the first concave mirror which are coaxially arranged can ensure that the reflected light beam can be accurately refocused to the pre-determined area, and also simplify the structure of the device.

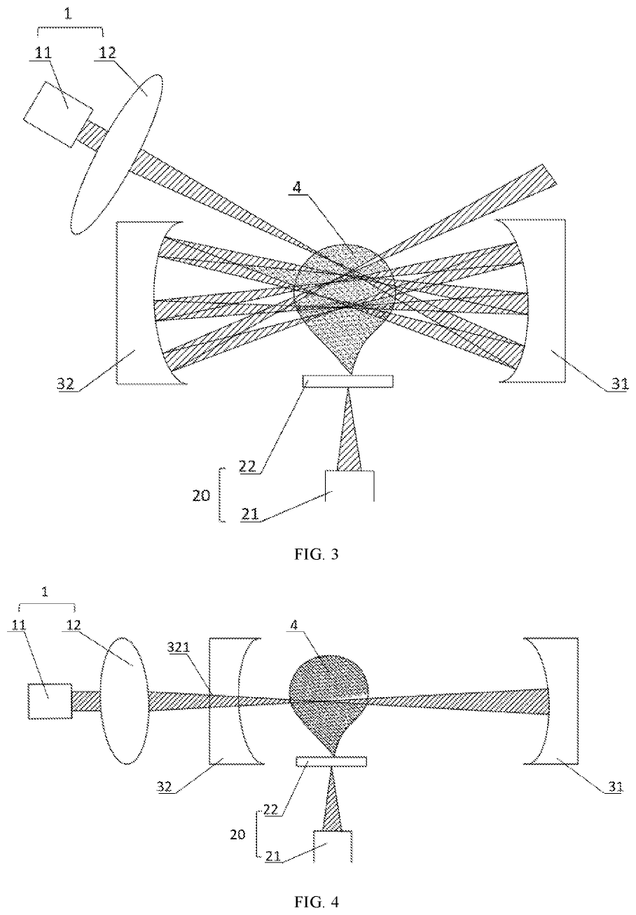

FIG. 3 is a structural schematic view of a focusing reflector 3 of an ion generator provided by another embodiment of the present disclosure. The ion generator in FIG. 3 differs from that in FIG. 2 in that the focusing reflector 3 in FIG. 3 includes a first concave mirror 31 and a second concave mirror 32, the first concave mirror 31 and the second concave mirror 32 are arranged opposite to each other with the pre-determined area 4 therebetween, and the sphere center of the second concave mirror 32 is located in the pre-determined area 4. The first concave mirror 31 and the second concave mirror 32 are arranged opposite to each other with the pre-determined area 4 therebetween, and the sphere centers thereof are both arranged in the pre-determined area 4, so that the light beam focused to the pre-determined area 4 from the light source 1 can be reflected between the first concave mirror 31 and the second concave mirror 32. Each time the light beam is reflected, the light beam will be focused to the pre-determined area 4 again, so that the light beam can be focused at a higher intensity and the light beam after being focused at a higher intensity can overlap with the sample particles in the pre-determined area 4, which further enhances the dissociation efficiency of the ion generator.

In particular, the light beam emitted by the light source 1 is incident to the surface of the first concave mirror 31 adjacently to the edge of the second concave mirror 32. On the basis of the optical properties of the light beam, when the light beam incident from the outside of the concave mirror is reflected between two concave mirrors having the same or similar sphere centers, in the case where the reflective surfaces of the concave mirrors are unchanged, the greater the angle of incidence (the angle between the light beam and the optical axis of the concave mirror), the fewer the number of reflections, so that incidence of the light beam from the edge of the second concave mirror 32 results in the greatest number of focusing and reflections. In addition, compared with the technique that the light beam is incident from a semi-transparent mirror to a resonant cavity in the prior art, the energy loss of light during incidence can be avoided.

FIG. 4 is a structural schematic view of a focusing reflector 3 provided by still another embodiment of the present disclosure. As shown in FIG. 4, the second concave mirror 32 has a through hole 321, and the light beam is incident on the surface of the first concave mirror 31 through the through hole 321.

In this embodiment, when the light beam incident from the through hole 321 of the second concave mirror 32 is reflected between the first concave mirror 31 and the second concave mirror 32 having the same or similar sphere centers, the light beam can be reflected back and forth between the reflective surfaces of the first concave mirror 31 and the second concave mirror 32 a certain number of times, without being fast emitted out of the range of the first concave mirror 31 and the second concave mirror 32, which increases the time and space in which the light beam overlaps with the sample particles to the greatest extent. Moreover, compared with the mode in the prior art that the light beam is incident by passing the semi-transparent mirror, the light beam is incident from the through hole 321, so that it is possible to avoid the energy consumption of the light beam during incidence

Further, in other embodiments of the present disclosure, the reflective surfaces of the first concave mirror 31 and the second concave mirror 32 in FIG. 3 or FIG. 4 may also be arranged as curved surfaces extending around a common sphere center. Or, in the embodiments of the present disclosure, the first concave mirror 31 and the second concave mirror 32 may also be arranged as a plurality of concave mirror assemblies with the same sphere center. The sphere centers of the plurality of concave mirror assemblies are all arranged in the pre-determined area 4, so that the number of reflections of the light beam between the first or second concave mirrors 32 can be increased, and the time and space in which the light beam overlaps with the sample ions can be enhanced. On this basis, when the area of the reflective surfaces of the first concave mirror 31 and the second concave mirror 32 is substantially equal to the area of a spherical surface with the pre-determined area 4 as a sphere center, the light beam can be in contact with the reflective surface at any position within the spherical surface to be reflected, which increases the number of times at which the light beam overlaps with the sample particles to the greatest extent, i.e., the time and space in which the light beam overlaps with the sample particles are increased.

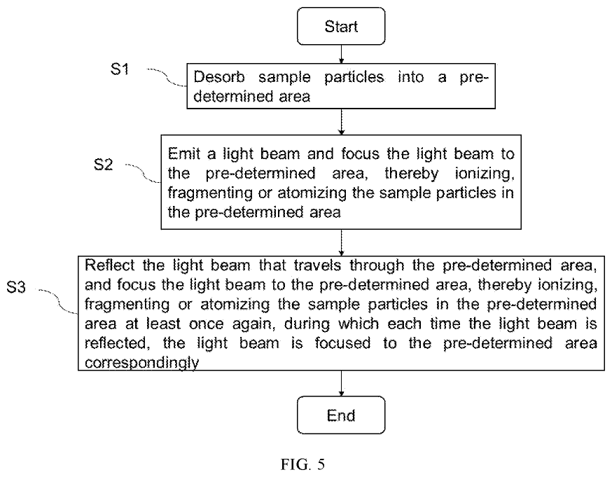

FIG. 5 is a flow chart of a method of generating ions provided by an embodiment of the present disclosure. The dissociation process of the ion generator is described below in conjunction with FIG. 2 and FIG. 5.

First, the matrix-assisted laser desorption device 20 of the ion generator performs step S1: desorbing sample particles to the pre-determined area 4. Specifically, the laser light source 21 of the matrix-assisted laser desorption device 20 emits laser to the substance sample on the sample electrode plate to dissociate the substance sample for the first time. The substance sample generates particle plume after first-time dissociation. The particle plume escapes to the pre-determined area 4 near the sample electrode plate 22.

Then, the light source 1 of the ion generator performs step S2: emitting a light beam and focusing the light beam to the pre-determined area 4, thereby ionizing, fragmenting, or atomizing the sample particles within the pre-determined area 4. Specifically, the beam generator 11 of the light source 1 emits a parallel light beam, and the parallel light beam passes through a convex lens and then is focused in the pre-determined area 4 to overlap with the sample particles in the pre-determined area 4, so that the sample particles are dissociated (ionized, fragmented or atomized).

Finally, the focusing reflector 3 executes step 3: reflecting the light beam that travels through the pre-determined area 4, and focusing the light beam to the pre-determined area 4, thereby ionizing, fragmenting or atomizing the sample particles in the pre-determined area 4 at least once again, during which each time the light beam is reflected on the surface of the focusing reflector 3, the light beam is focused to the pre-determined area 4 correspondingly. Specifically, the focused light beam is incident on the surface of the concave mirror, and is reflected and focused to the pre-determined area 4 again, thereby dissociating the particle plume in the pre-determined area 4.

In this embodiment, the sample particles can be dissociated three times by means of simple device setting, so that the degree of dissociation of the sample particles can be effectively enhanced in the aspect of the time and space in which the light beam overlaps with the sample particles. The light beam emitted by the light source 1 of the ion generator provided by this embodiment is focused to the pre-determined area 4. The reflected light beam is focused to the pre-determined area 4 again, so that the energy of high-energy photons irradiating the sample particles in the pre-determined area 4 can be effectively improved under the condition that the beam energy is the same, which improves the degree of dissociation of the sample particles, thus enhancing the dissociation efficiency of the ion generator.

Because the dissociation of the sample particles by the matrix-assisted laser desorption device 20 is relatively mild, the particle plume generated after the first-time dissociation contains a large number of neutral particles. The particle plume after being dissociated by the matrix-assisted laser desorption device 20 are dissociated for the second time, which can effectively increase the proportion of effective particles in the particle plume, so that the overall dissociation efficiency of the ion generator is improved. It is to be noted that, because the matrix-assisted laser desorption device 20 is often applied to some difficult-to-vaporize or heat-sensitive substances, such as biological samples, it is difficult to vaporize such substances to produce particles, which greatly increases the difficulty of dissociation. However, the ion generator provided in this embodiment first dissociate the sample for the first time by means of the mild matrix-assisted laser desorption device 20 and then dissociates the particle plume produced after the first-time dissociation for the second time, thereby producing the sample particles without vaporizing the sample, and increasing the degree of dissociation of the sample by dissociating the sample particles many times, which makes it easier for a substance analyzer to analyze the composition of such substances.

Depending on the actual application scenario, substance detecting instruments using the ion generator of the present disclosure may include or be replaced by various mass spectrometers, ion mobility spectrometers, chromatographs, spectrometers, and electrochemical analyzers.

In other embodiments of the present disclosure, a mass spectrometer is further provided and includes the ion generator in any of the above embodiments. The mass spectrometer is capable of analyzing ions, ion fragments or atoms obtained from dissociation of the ion generator.

Up to this point, the technical solution of the present disclosure has been described in conjunction with the accompanying drawings, however, it is to be easily understood by those skilled in the art that the scope of protection of the present disclosure is obviously not limited to these specific implementations. Without deviating from the principle of the present disclosure, those skilled in the art may make equivalent changes or substitutions to the relevant technical features, and the technical solutions after these changes or substitutions shall fall within the scope of protection of the present disclosure.

1. An ion generator comprising:
a desorption device configured to desorb sample particles into a pre-determined area:
a light source emitting a light beam and focusing the light beam to the pre-determined area, thereby ionizing, fragmenting or atomizing the sample particles in the pre-determined area; and
a focusing reflector for reflecting the light beam that is emitted by the light source and travels through the pre-determined area, and focusing the light beam to the pre-determined area, thereby ionizing, fragmenting or atomizing the sample particles in the pre-determined area at least once again, during which each time the light beam is reflected on the surface of the focusing reflector, the light beam is focused to the pre-determined area correspondingly.

2. The ion generator according to claim 1, wherein the focusing reflector comprises a first concave mirror arranged opposite to the light source with the pre-determined area therebetween, and sphere center of the first concave mirror is located in the pre-determined area.

3. The ion generator according to claim 2, wherein the focusing reflector further comprises a second concave mirror arranged opposite to the first concave mirror with the pre-determined area therebetween, and sphere center of the second concave mirror is located in the pre-determined area.

4. The ion generator according to claim 3, wherein the light beam is repeatedly reflected and focused to the pre-determined area between the first concave mirror and the second concave mirror.

5. The ion generator according to claim 4, wherein the light beam is incident on a surface of the first concave mirror adjacently to the edge of the second concave mirror.

6. The ion generator according to claim 4, wherein the second concave mirror has a through hole, and the light beam is incident on the surface of the first concave mirror through the through hole.

7. The ion generator according to claim 2, wherein the light source comprises a convex lens whose focal point is in the pre-determined area.

8. The ion generator according to claim 7, wherein optical axis of the convex lens is coaxial with optical axis of the first concave mirror.

9. The ion generator according to claim 1, wherein the sample particles are ions, neutral particles, or a combination of both.

10. The ion generator according to claim 1, wherein the desorption device is a laser desorption device, a thermal desorption device, an ultrasonic desorption device, or a combination thereof.

11. The ion generator according to claim 10, wherein the desorption device is a matrix-assisted laser desorption device, and the pre-determined area is the area adjacent to the sample electrode plate of the matrix-assisted laser desorption device and traversed by the particle plume of the matrix-assisted laser desorption device.

12. The ion generator according to claim 1, wherein the energy loss caused each time the light beam is reflected and focused by the focusing reflector is less than 10%.

13. An ion generator comprising:
a matrix-assisted laser desorption device having a sample electrode plate:
a laser light source:
a convex lens coaxially arranged with the laser light source, whose focal point is in the pre-determined area that is adjacent to the sample electrode plate of the matrix-assisted laser desorption device and traversed by the particle plume of the matrix-assisted laser desorption device;
a first concave mirror arranged opposite to the laser light source with the pre-determined area therebetween, whose sphere center is located in the pre-determined area.

14. The ion generator according to claim 13, further comprising a second concave mirror arranged opposite to the first concave mirror with the pre-determined area, and the sphere center of the second concave mirror is located in the defined area.

15. The ion generator according to claim 13, wherein the matrix-assisted laser desorption device further comprises a mirror system for the control of the deflecting angle of the desorption laser, in order for the position control of the desorption laser spots on the sample electrode plate.

16. A mass spectrometer comprising the ion generator according to claim 1.

17. A method of generating ions, comprising following steps:
desorbing sample particles into a pre-determined area;
emitting a light beam and focusing the light beam to the pre-determined area, thereby ionizing, fragmenting or atomizing the sample particles in the pre-determined area;
reflecting the light beam that travels through the pre-determined area, and focusing the light beam to the pre-determined area, thereby ionizing, fragmenting or atomizing the sample particles in the pre-determined area at least once again, during which each time the light beam is reflected on the surface of the focusing reflector, the light beam is focused to the pre-determined area correspondingly.
